(19) United States
(12) Patent Application Publication
(10) Pub. No.: US 2019/0241260 A1
(43) Pub. Date: Aug. 8, 2019

(54) ROTARY AIRCRAFT AND METHOD OF USE

(71) Applicant: Khaled Abdullah Alhussan, Riyadh (SA)

(72) Inventor: Khaled Abdullah Alhussan, Riyadh (SA)

(21) Appl. No.: 16/269,521

(22) Filed: Feb. 6, 2019

Related U.S. Application Data
(60) Provisional application No. 62/626,873, filed on Feb. 6, 2018.

(51) Int. Cl. B64C 27/28; B64C 39/02; B64C 29/00; B64C 27/26

(52) U.S. Cl. CPC B64C 27/28; B64C 39/024; B64C 2201/108; B64C 27/26; B64C 2201/027; B64C 29/0033

(57) ABSTRACT

A rotary aircraft with a hybrid power source includes a streamlined body extending from a front end to a back end; a forward wing rigidly attached to and extending from a front section near the front end, the forward wing having a first section and a second section rigidly attached to the body and extending in directions opposing each other; an aft wing rigidly attached to and extending from a back section near the back end, the aft wing having a third section and a fourth section rigidly attached to the body and extending in directions opposing each other; a first rotor assembly secured to the first section and configured to create lift and thrust during flight; a second rotor assembly secured to the second section and configured to create lift and thrust during flight; a third rotor assembly secured to the third section and configured to create lift and thrust during flight; a fourth rotor assembly secured to the fourth section and configured to create lift and thrust during flight; and a center rotor assembly moveably attached to the body and configured to create lift and thrust during flight.

### BACKGROUND

### 1. Field of the Invention

The present invention relates generally to rotary aircrafts, and more specifically, to a rotary aircraft with a hybrid power source and having a plurality of rotor assemblies utilized to create lift and thrust, wherein a center rotor assembly pivots relative to the body and is disposed between four outer rotor assemblies.

### 2. Description of Related Art

Rotary aircraft are well known in the art and are effective means to create vertical and horizontal flight. One exemplary type of rotary aircraft is an unmanned aerial vehicle, more specifically, a drone. FIG. 1 depicts an oblique view of a conventional drone 101 having a body 105 with a plurality of arms extending from an outer surface of the body 105 and configured to hold one or more rotor assemblies 103. The rotor assemblies 103 are configured to create lift and thrust for flight. A plurality of legs 107 extend from a bottom surface of the body 105 and are configured to keep the drone body at a height relative to the ground surface during non-flight.

One of the problems commonly associated with drone 101 is the limited use. Although effective in vertical lift, the drone 101 has limitations in horizontal movement due to the rotary assemblies being fixed in the upright position. Accordingly, the exemplary embodiment provides little forward thrust without the body 105 being oriented at an angle relative to the ground surface to create the forward thrust vector via the rotor assemblies 103.

Another disadvantage with drone 101 is that the arms provide little to no lift during flight. Accordingly, the sole lift is created by the rotor assemblies during flight. Further, the arms can create substantial drag; a limitation that slows down the drone and creates additional undesired issues such as additional fuel consumption and associated costs.

Accordingly, although great strides have been made in the area of drone technology, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is an oblique view of a conventional rotary aircraft;

FIG. 2 is an oblique view of a rotary aircraft in accordance with a preferred embodiment of the present application;

FIGS. 3A and 3B are side views of the rotary aircraft of FIG. 2;

FIG. 4 is a top view of the aircraft of FIG. 2;

FIG. 5 is a back view of the aircraft of FIG. 2;

FIG. 6 is an oblique view of a rotary aircraft in accordance with an alternative embodiment of the present invention;

FIGS. 7, 8A-8D are side views of the aircraft of FIG. 6;

FIG. 9 is a top view a rotary aircraft in accordance with an alternative embodiment of the present invention;

FIGS. 10A and 10B are side views of a rotary assembly in accordance with one preferred embodiment of the present invention;

FIGS. 11 and 12 are cross-sectional side views of wings of the aircraft of FIG. 9 taken at XI-XI and XII-XII, respectively;

FIG. 13 is a flowchart of the method of flying the aircraft of FIG. 9 through a hybrid system; and

FIG. 14 is a top view of the rotary aircraft of FIG. 6 with dimensions.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional rotary aircraft. Specifically, the present application is directed to a rotary aircraft having a plurality of rotor assemblies utilized to create vertical lift and horizontal thrust during flight. It will be appreciated that the rotor assemblies are used yaw movement in addition to creating lift and thrust. The drone utilizes a center rotor assembly configured to pivot relative to the aircraft body and adapted to create additional horizontal thrust during flight. The drone is further provided with forward and aft wings to create lift during flight and to manipulate the airflow to enhance flight maneuverability. In the preferred embodiment, the system is preferably referred to as a petacopter. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

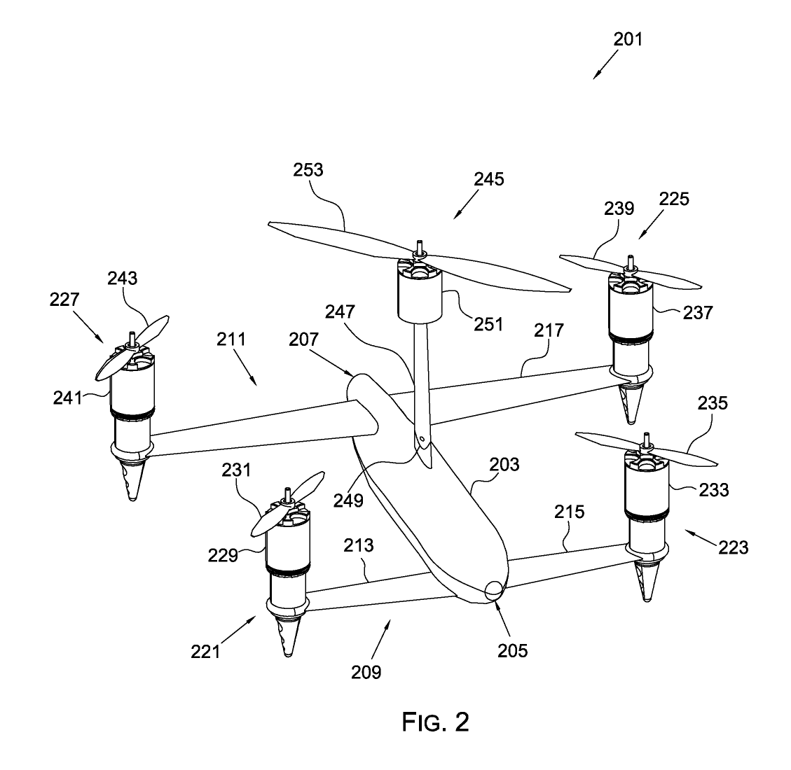

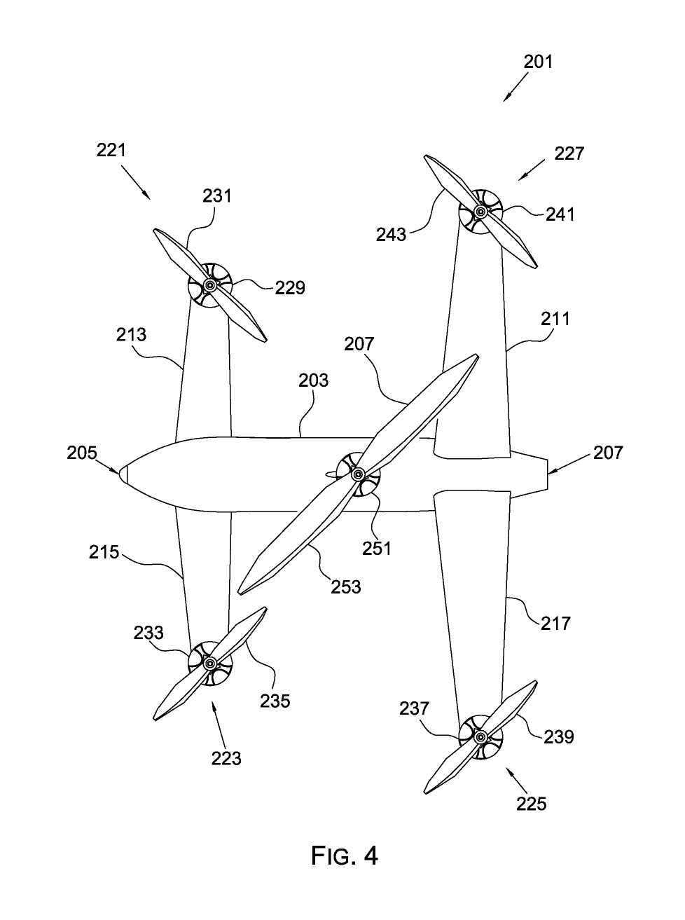

Referring now to the drawings wherein like reference characters identify corresponding or similar elements throughout the several views, FIGS. 2-5 depicts various views of a rotary aircraft 201 in accordance with one preferred embodiment of the present application. It will be appreciated that aircraft 201 overcomes one or more of the above-listed problems commonly associated with conventional rotary aircraft. In the preferred embodiment, the rotary aircraft 201 is an unmanned aerial vehicle; however, it will be appreciated that the teachings discussed herein could be utilized on manned aircraft.

In the contemplated embodiment, aircraft 201 includes one or more of a streamlined body 203 extending from a tapered front end 205 to a back end 207 having a linear, flat surface. As will be discussed more fully below, the linear, flat back surface accommodates the center rotor assembly as it pivots at a 90 degree angle relative to the body. The preferred embodiment includes a body 203 that forms a hollow interior for securing one or more of a drive assembly, power assemblies, actuators, computer devices, transmitters, electronics, and other associated components necessary to control flight maneuverability and to power the rotor assemblies during flight.

Although not shown, it will be appreciated that the intended use of aircraft 201 could include features such as carrying a payload (not shown) between locations, reconnaissance, picture taking, leisure activities, and the like. Accordingly, the aircraft 201 could be adapted with a quick-release devices secured to the body and configured to releasably engage with one or more payloads.

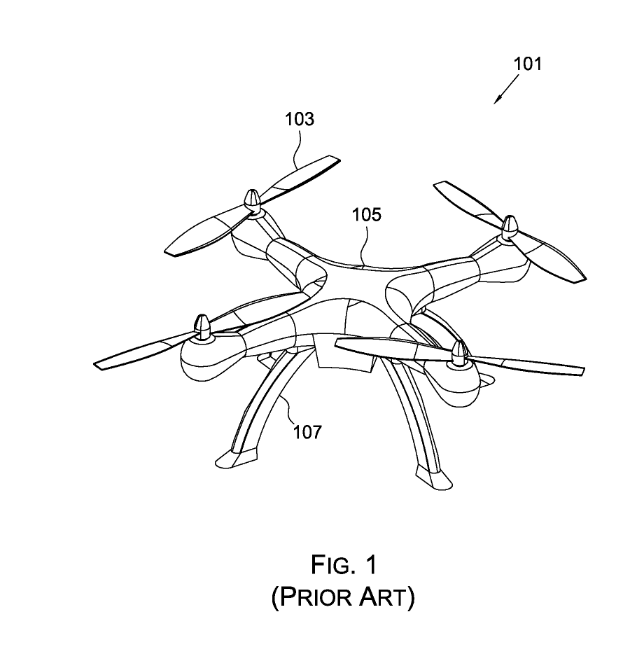

The aircraft 201 is further provided with a forward wing 209 rigidly secured to a front section of the body 203 near the front end 205, while an aft wing 211 is rigidly secured to a rear section of the body 203 near the back end 207. During flight, the wings 209, 211 are contoured to provide additional lift and could include flaps, ailerons, and the like to manipulate airflow around the wings. Accordingly, one of the unique features believed characteristic of the present invention is the use of wings in lieu of conventional arms, as depicted in FIG. 1.

It will be appreciated that the wings 209, 211 are spaced apart at a height “H” relative to each other, which in turn positions the front rotor assemblies and the back rotor assemblies at a height difference relative to each other. These feature provide further stability and control of the aircraft during flight. In the contemplated embodiment, wing 209 includes wing sections 213, 215, while wing 211 includes sections 217, 219; whereas an alternative embodiment could include a single wing in lieu of sections. In the preferred embodiment, the height “H” is at a fixed position; however, it will be appreciated that alternative embodiments could include wings that have variable heights “H.”

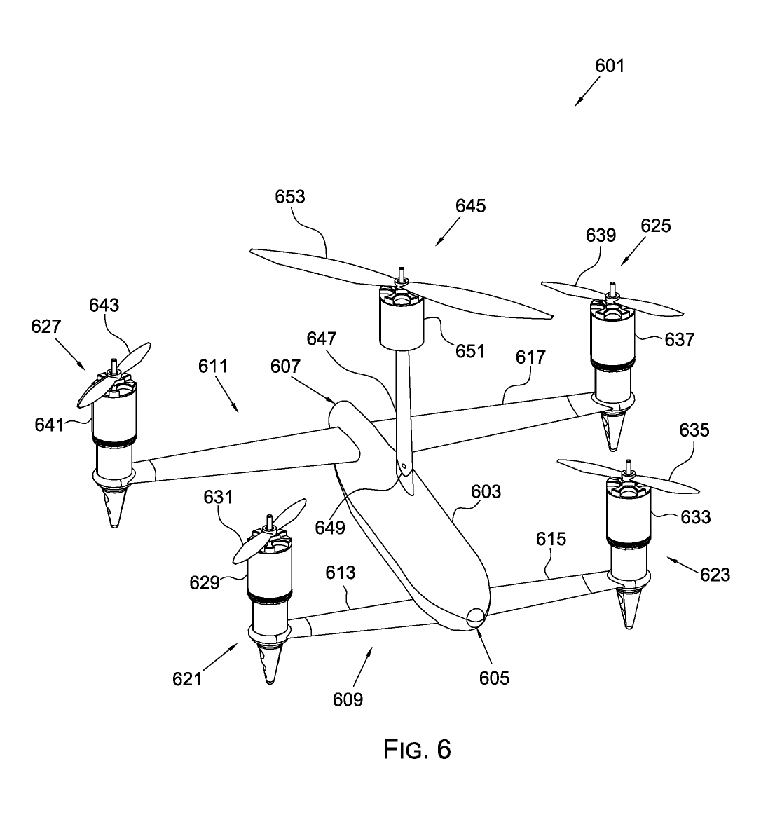

The aircraft 201 preferably includes four rotary assemblies 221, 223, 225, and 227 rigidly fixed to respective wing sections 213, 215, 217, and 219. It should be appreciated that in the exemplary embodiment, the rotor assemblies are rigidly fixed in the upright position relative to the wing sections; however, it should be known that alternative embodiments could include rotary assemblies that pivot relative to the wing sections. For example, FIG. 6 illustrates an alternative embodiment of the rotary aircraft 201 wherein the aircraft has rotary assemblies configured to pivot relative to the wing sections. This feature further enhances flight maneuverability and control.

In the exemplary embodiment, the rotor assembly 221 includes a motor 229 configured to rotate rotor 231 and likewise rotor assembly 223 includes a motor 233 rotatably attached to rotor 235, rotor assembly 225 includes a motor 237 rotatably attached to rotor 239, and rotor assembly 227 includes a motor 241 rotatably attached to rotor 243.

During use, the four rotor assemblies are utilized to create vertical lift and horizontal thrust. In one exemplary embodiment, the pitch of the rotor blades could vary, which in turn could create horizontal thrust. However, the primary forward flight thrust is created by a center rotor assembly 245 carried at a distance relative to the body 203 via a contoured wing 247. In the exemplary embodiment, the rotor assembly 245 is provided with a motor 251 rotatably attached to a rotor blade 253.

It is contemplated that the wing 247 is pivotally attached to body 203 about a pivot joint 249. Although not shown in detail, the pivot joint 249 could be operably associated with drive system such as a link assembly, hydraulic apparatus, gear assembly, motor, and the like. During flight, the drive system (not shown) pivots the center rotor assembly 245 to manipulate vertical lift and horizontal thrust. Accordingly, another unique feature believed characteristic of the present invention is the use of a center rotor assembly configured to provide additional lift and thrust in addition to the four outer rotor assemblies.

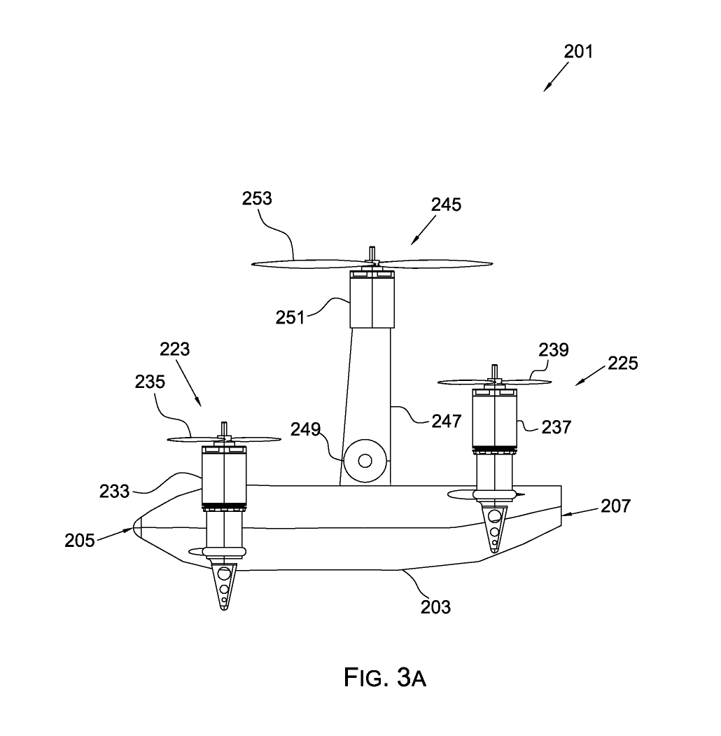

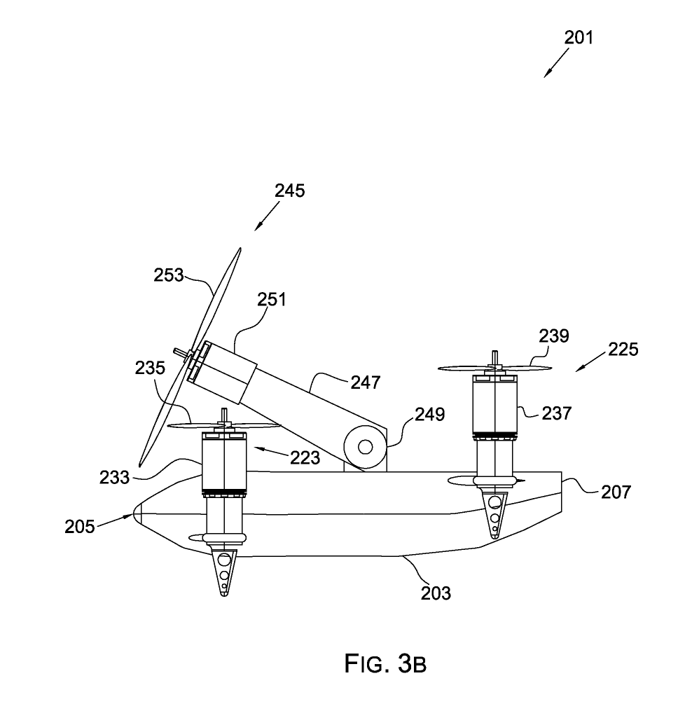

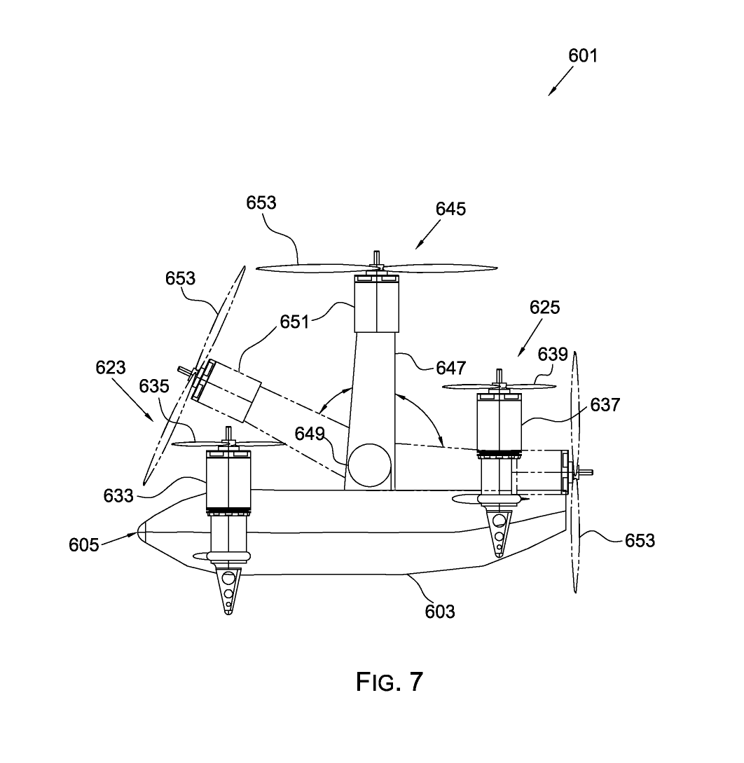

In FIGS. 3A and 3B, the pivoting movement of the center assembly 245 relative to the body 203 is shown. It should be understood that the rotor assembly could be adapted to oriented in a forward facing and a rear facing position to create lift and thrust. The angle of orientation could be incremental to manipulate the amount of lift and thrust during flight. These features are shown in at least FIG. 7, wherein the center assembly could rest on the body 203. In yet another embodiment, it is contemplated having a center rotor assembly 245 configure to rotate about pivot joint 249. This feature further enhances flight maneuverability.

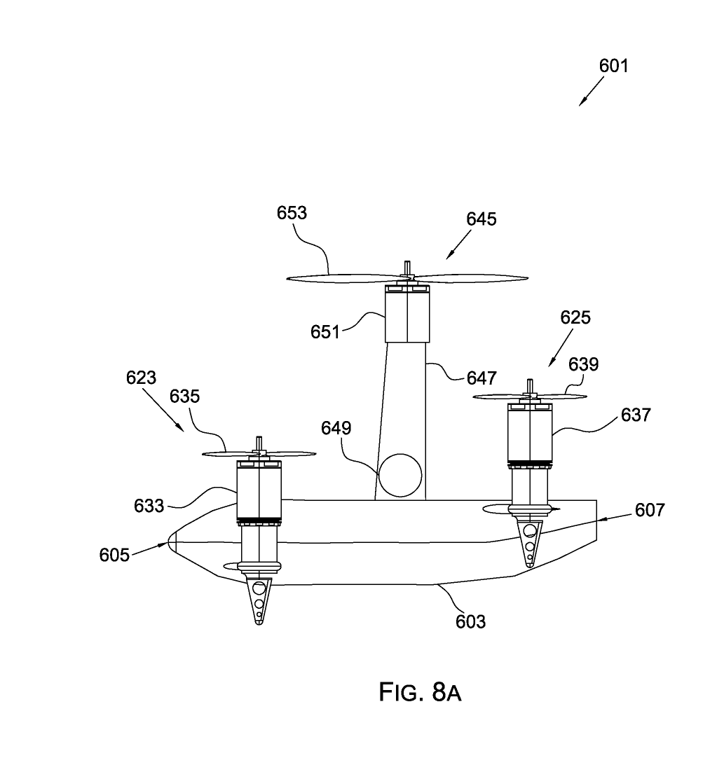

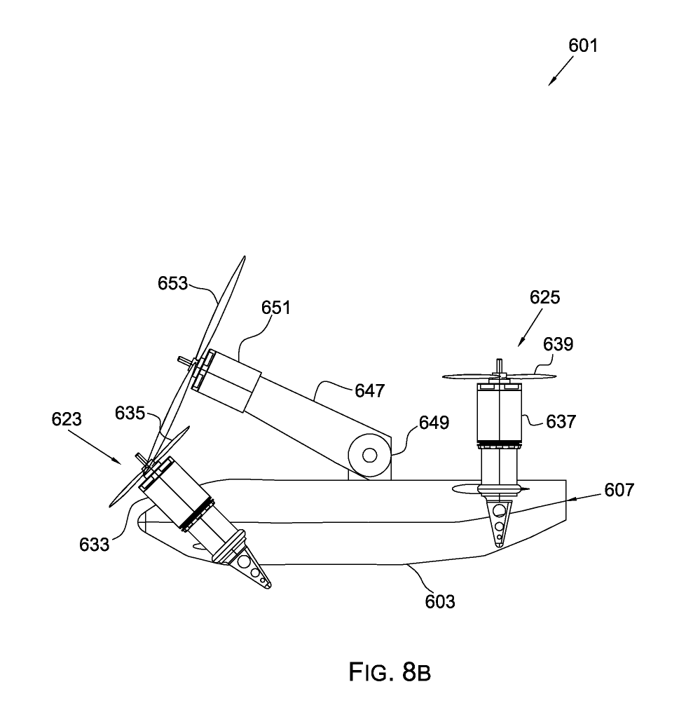

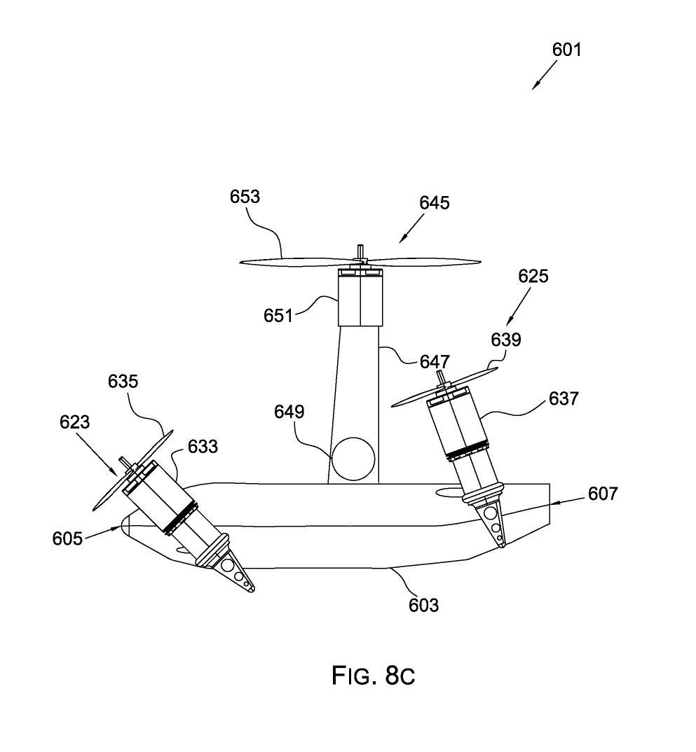

Referring now to FIGS. 6-8D in the drawings, an alternative embodiment of aircraft 201 is shown. It will be appreciated that rotary aircraft 601 is substantially similar in form and function to aircraft 201; however, it should be understood that aircraft further includes the feature of one or more rotor assemblies that rotate relative to the wing sections. Accordingly, it is contemplated that aircraft 601 further enhances flight maneuverability with this feature.

The drawings illustrate like reference characters that identify corresponding or similar elements throughout the several views. It will be appreciated that aircraft 601 also overcomes one of more of the above-listed problems commonly associated with conventional rotary aircraft, as discussed above.

In the contemplated embodiment, aircraft 601 includes one or more of a streamlined body 603 extending from a tapered front end 605 to a back end 607 having a linear surface. The body 603 preferably forms a hollow interior for securing drive systems, power assemblies, actuators, computer devices, and other associated components necessary to control flight maneuverability.

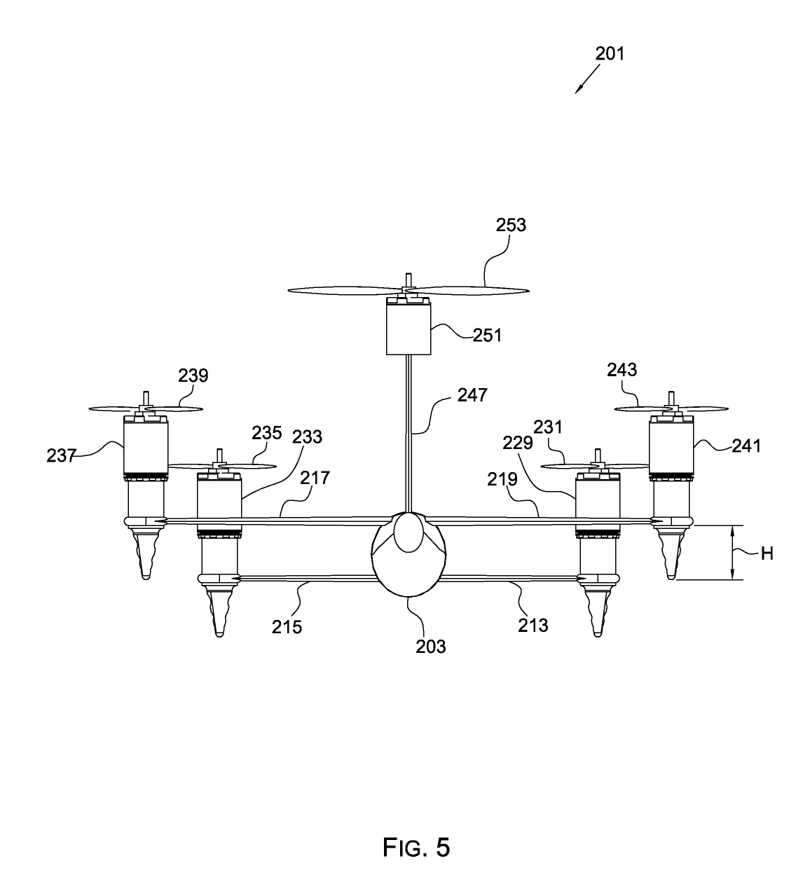

A forward wing 609 rigidly secures to a section of the body 603 near the front end 605, while an aft wing 611 is rigidly secured to a section of the body 603 near the back end 607. During flight, the wings 609, 611 provide additional lift and could include flaps 300, ailerons, and the like to manipulate airflow about the outer surface of the wings. As depicted in FIG. 5, the wings are spaced apart at a height “H” relative to each other. This feature provides further stability and control of the airflow around the wings during flight. In the contemplated embodiment, wing 609 includes wing sections 613, 615, while wing 611 includes sections 617, 619.

In this contemplated embodiment, the wing 609 includes sections 608 configured to pivotally attach to a section 610 that is rigidly attached to body 603. Likewise wing 609 includes a second section 614 configured to pivotally attach to a second section 612 rigidly attached to body 603. The wing 611 includes sections 600 configured to pivotally attach to a section 602 that is rigidly attached to body 603. Likewise wing 611 includes a second section 606 configured to pivotally attach to a second section 604 rigidly attached to body 603.

In yet another embodiment, the rotor assemblies 621, 623, 625, and 627 could be pivotally attached to respective sections 608, 614, 606, and 600. This feature further enhances flight maneuverability and performance.

The aircraft 601 preferably includes four rotary assemblies 661, 663, 665, and 667 pivotally attached to respective wing sections 613, 615, 617, and 619. It will be appreciated that the rotary assemblies could be independently controlled, e.g., pivot and various angles relative to each other to further enhance flight maneuverability.

In the exemplary embodiment, the rotor assembly 661 includes a motor 669 configured to rotate rotor 631 and likewise rotor assembly 663 includes a motor 633 rotatably attached to rotor 635, rotor assembly 665 includes a motor 637 rotatably attached to rotor 639, and rotor assembly 667 includes a motor 641 rotatably attached to rotor 643.

During use, the four rotor assemblies are utilized to create vertical flight. In one exemplary embodiment, the pitch of the rotor blades could vary, which in turn could create horizontal thrust. However, the primary forward flight thrust could be created by pivoting the rotary assemblies and/or a center rotor assembly 645 carried at a distance relative to the body 603 via a wing 647, which in turn is pivotally attached to body 603 about a pivot joint 649. Although not shown in detail, the pivot joint 649 could include a link assembly, hydraulic system, gear system, and the like to control rotational movement.

It should be appreciated that although wing 647 is shown pivotally attached to body 603, in alternative embodiments wing 647 can be fixed in a vertical position.

The rotor assembly 645 is provided with a motor 651 rotatably attached to a rotor 653. In FIGS. 3A and 3B, the rotation of the center assembly 645 is depicted, wherein the rotor assembly could be adapted to face forward relative to the body 603 to create a forward thrust vector. Likewise, the center assembly could be adapted to face in a direction rearward to create a rear thrust vector. These features are shown in at least FIG. 7, wherein the center assembly could rest on the body 603.

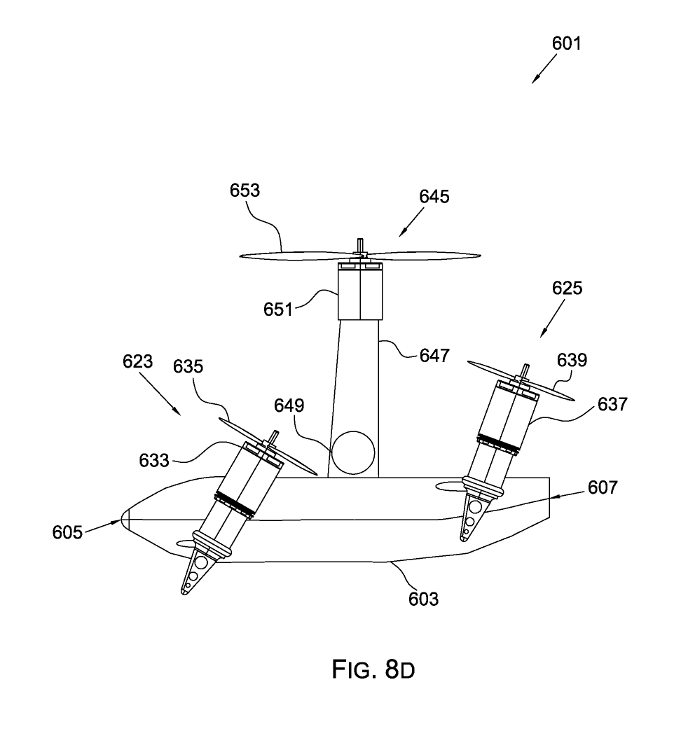

Referring now to FIG. 9, components of a drive system are shown in an exemplary embodiment. The drive system includes one or more of a gas engine 901 in fluid communication with a gas reservoir 911 that is carried an inner cavity of body 603. The gas engine 901 is adapted to rotate one or more of the rotor blades 631, 635, 639, 643, and 607. To achieve this feature, the gas engine 901 is rotatably attached to a plurality of drive shaft, for example, drive shafts 907, 908, 909, and 910 via one or more transmissions such as transmissions 903 and 905. The rotation of the drive shafts in turn rotates respective the one or more rotor blades 631, 635, 639, 643, and 607.

It will be appreciated that a drive system utilizing a gas engine could be utilized to drive the plurality of rotors in lieu of utilizing a plurality of motors, as depicted in the previous aircraft embodiments. This feature greatly reduces the weight associated with having a plurality of motors and associated batteries. In yet another embodiment, the gas motor could be utilized to drive a generator configured to power a plurality of electric motors. Further, the drive system could utilize a combination of batteries, generators, and gas engines.

In one contemplated embodiment, the center rotor assembly is powered by a gas engine, while the four corner rotors are driven by one or more electric motors, the electric motors powered by an alternator through the engine.

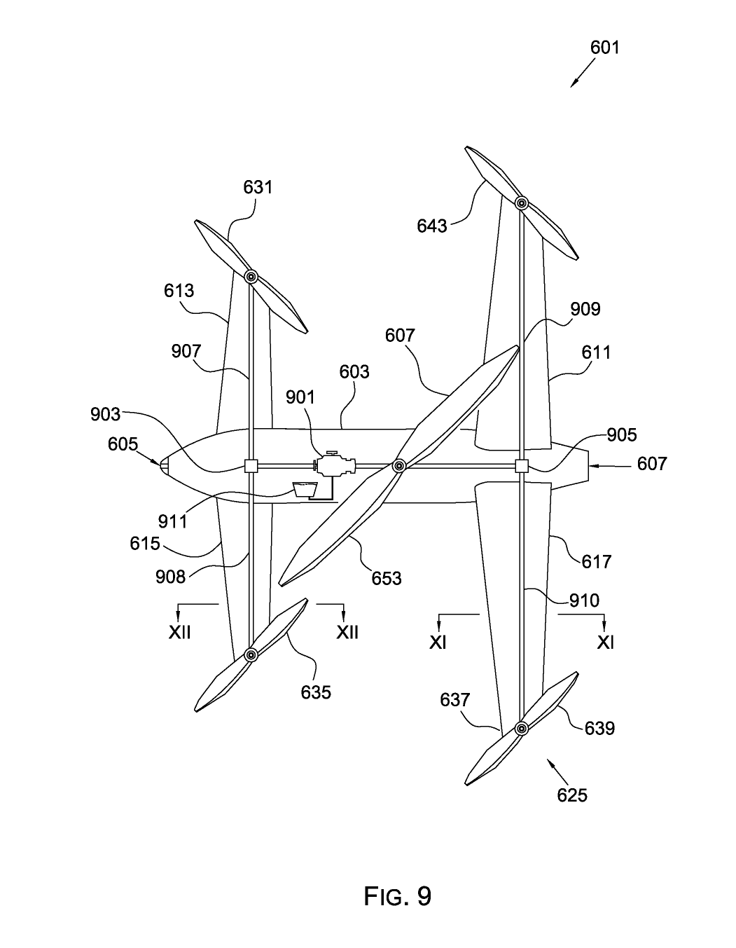

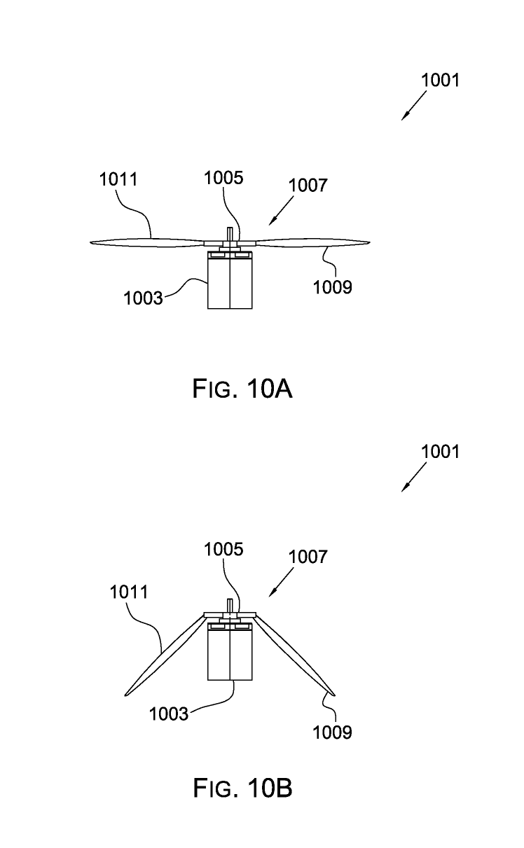

In FIGS. 10A and 10B, a rotor assembly 1001 is shown in accordance with an alternative embodiment of the present invention. In the exemplary embodiment, the rotor assembly 1001 includes a motor 1003 rotatably attached to a hub 1005 with a rotor blade 1007 secured thereto. The rotor blade 1007 includes a first blade section 1009 and a second blade section 1011. As depicted in FIG. 10B, the rotor blade sections are adapted to fold during non-flight. It will be appreciated that aircrafts 201 and 601 could utilize the features of rotary assembly 1001.

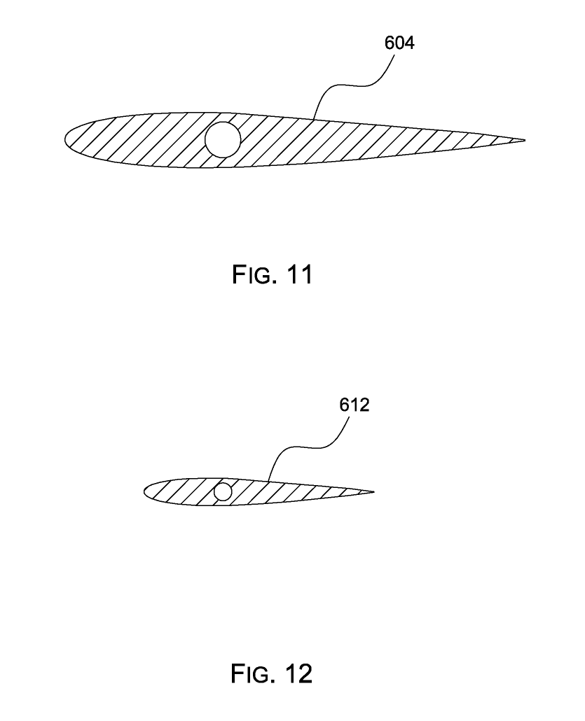

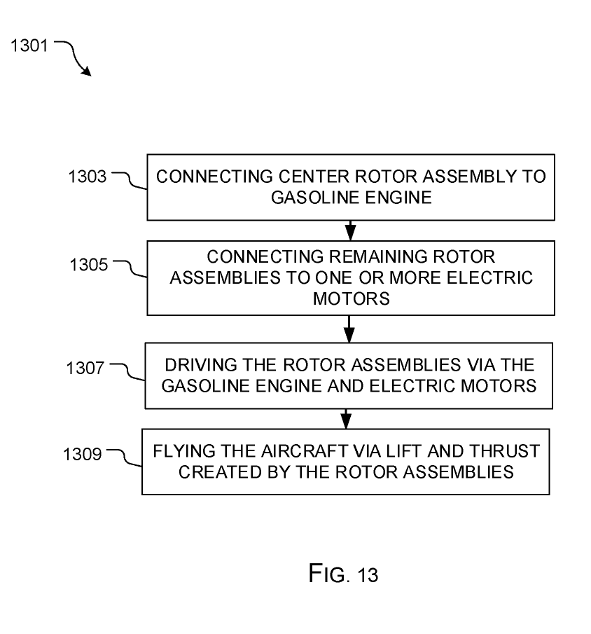

In FIGS. 11 and 12, cross-sectional views of wing sections 604 and 612 are shown taken at respective locations XI-XI and XII-XII of FIG. 9. In the preferred embodiment, the wing shapes and sizes are not identical. Accordingly, the flight performance of each wing is differently. It will be appreciated that the wing performance is different along with the wings being spaced at a different linear plane relative to the elongated length of the aircraft body. This feature provides effective means to further enhance flight maneuverability and performance during flight.

In FIG. 13, a flowchart 1301 depicts a method associated with the use of a hybrid drive system, wherein the center rotor assembly is powered via a gas engine, while the remaining rotors are driven by one or more electric motors. During use, the center rotor assembly is connected to a gas engine, wherein the gas engine drives the center assembly, of as shown with box 1303. One or more electric motors are connected to the exterior rotor assemblies, wherein the electric motors drive the exterior assemblies, as shown with box 1305. The drive of the gasoline engine and electric motors provides the necessary power to create lift and thrust necessary for flight of the aircraft via the rotor assemblies, as shown with box 1307 and 1309.

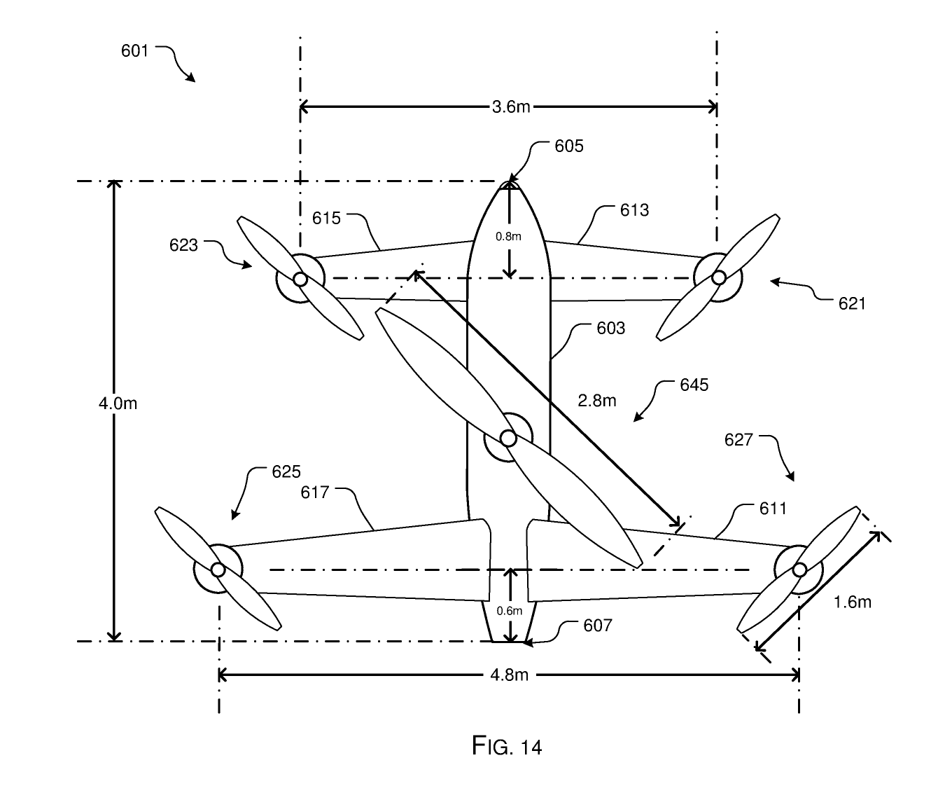

Referring now to FIG. 14, a top view of the rotary aircraft in accordance with the preferred embodiment is shown with dimensions. In one exemplary embodiment, the body length is 4.0 m with the rear wing span of 4.8 m and a front wing span of 3.6 m. It is also preferred to place the two front rotors along an axis located at 0.8 m from the front of the body, while placing the two rear rotors along an axis located at 0.6 m from the back of the body. The center rotor is placed at the center of the longitudinal length of the body. The rotor blade lengths are preferably 2.8 m for the center rotor, while a 1.6 m length for the remaining four rotor blades.

It will be appreciated that FIG. 14 depicts one of many different design choices and should not be limited in scope an protection to the particular lengths shown herein.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A rotary aircraft, comprising:
a streamlined body extending from a front end to a back end;
a forward wing rigidly attached to and extending from a front section near the front end, the forward wing having a first section and a second section rigidly attached to the body and extending in directions opposing each other;
an aft wing rigidly attached to and extending from a back section near the back end, the aft wing having a third section and a fourth section rigidly attached to the body and extending in directions opposing each other;
a first rotor assembly secured to the first section and configured to create lift and thrust during flight;
a second rotor assembly secured to the second section and configured to create lift and thrust during flight;
a third rotor assembly secured to the third section and configured to create lift and thrust during flight;
a fourth rotor assembly secured to the fourth section and configured to create lift and thrust during flight; and
a center rotor assembly moveably attached to the body and configured to create lift and thrust during flight;
wherein the first rotor assembly, the second rotor assembly, the third rotor assembly, and the center rotor assembly simultaneously create lift and thrust during flight.

2. The aircraft of claim 1, wherein the center rotor is configured to pivot relative to the body up to 90 degrees relative to a center axis of the body;

3. The aircraft of claim 1, wherein the forward wing has a different camber than the aft wing.

4. The aircraft of claim 1, wherein a chord line of the forward wing is at a different plane height than a chord line of the aft wing.

5. The aircraft of claim 1, wherein the streamlined body has a center axis extending the longitudinal length of the body;
wherein the forward wing is positioned below a dimensional plane that extends along the center axis of the body; and
wherein the aft wing is positioned above the dimensional plane that extends along the center axis of the body.

6. The aircraft of claim 1, the first rotor assembly having:
a rotor blade rotatably attached to a motor.

7. The aircraft of claim 6, the rotor blade having:
a first section pivotally attached to a rotor hub; and
a second section pivotally attached to the rotor hub;
wherein the first section and the second section pivot relative to the rotor hub;
wherein the rotor blade folds during non-flight.

8. The aircraft of claim 1, wherein the first rotor assembly pivots relative to the first section.

9. The aircraft of claim 1, wherein the center rotor assembly is secured at a distant position relative to the streamlined body via a center wing extending in a direction relatively perpendicular to the first section.

10. The aircraft of claim 9, wherein the center wing is rotably attached to the streamlined body about a pivot joint.

11. The aircraft of claim 10, wherein the center wing is positioned at a location between the forward wing and the aft wing.

12. The aircraft of claim 1, wherein the body has an overall length of 4.0 m.

13. The aircraft of claim 1, wherein the forward wing has a length of 3.6 m.

14. The aircraft of claim 1, wherein the forward wing has a length of 4.8 m.

15. The aircraft of claim 1, wherein the center rotor blade is 2.8 m in length.

16. A rotary aircraft, comprising:
a streamlined body extending from a front end to a back end, the streamlined body having a center axis extending the longitudinal length of the body;
a forward wing rigidly attached to and extending from a front section near the front end, the forward wing having a first section and a second section rigidly attached to the body and extending in directions opposing each other, the forward wing being positioned below a dimensional plane that extends along the center axis of the body;
an aft wing rigidly attached to and extending from a back section near the back end, the aft wing having a third section and a fourth section rigidly attached to the body and extending in directions opposing each other, the aft wing being positioned above the dimensional plane that extends along the center axis of the body;
a first rotor assembly secured to the first section and configured to create lift and thrust during flight;
a second rotor assembly secured to the second section and configured to create lift and thrust during flight;
a third rotor assembly secured to the third section and configured to create lift and thrust during flight; and
a fourth rotor assembly secured to the fourth section and configured to create lift and thrust during flight;
wherein the forward wing has a different thickness than a thickness of the aft wing.

17. The aircraft of claim 16, further comprising:
a center rotor assembly moveably attached to the streamlined body and configured to create lift and thrust during flight;
a drive system disposed within a hollow interior of the center rotor assembly, the drive system being configured to simultaneously rotate the first rotor assembly, the second rotor assembly, the third rotor assembly, the fourth rotor assembly, and the center rotor assembly;
wherein the first rotor assembly, the second rotor assembly, the third rotor assembly, and the center rotor assembly simultaneously create lift and thrust during flight.

18. The aircraft of claim 17, the drive system having:
a gas powered engine in fluid communication with a gas reservoir disposed within the hollow interior of the body; and
a transmission rotatably connected to the gas powered engine; and
a plurality of shafts rotatably attached to the transmission and configured to rotate the rotor assemblies;
wherein the rotor assemblies are powered by a plurality of input shafts rotatably attached to the transmission.

19. The aircraft of claim 1, wherein the body has an overall length of 4.0 m, the forward swing has a length of 3.6 m, forward wing has a length of 4.8 m, and the center rotor blade is 2.8 m in length.

20. A method to create vertical lift and forward flight of an aircraft, comprising:
providing an aircraft having:
a streamlined body extending from a front end to a back end;
a forward wing rigidly attached to and extending from a front section near the front end, the forward wing having a first section and a second section rigidly attached to the body and extending in directions opposing each other;
an aft wing rigidly attached to and extending from a back section near the back end, the aft wing having a third section and a fourth section rigidly attached to the body and extending in directions opposing each other;
a first rotor assembly secured to the first section and configured to create lift and thrust during flight;
a second rotor assembly secured to the second section and configured to create lift and thrust during flight;
a third rotor assembly secured to the third section and configured to create lift and thrust during flight;
a fourth rotor assembly secured to the fourth section and configured to create lift and thrust during flight; and
a center rotor assembly moveably attached to the body and configured to create lift and thrust during flight; the center wing is positioned at a location between the forward wing and the aft wing;
simultaneously create lift and thrust during flight with the first rotor assembly, the second rotor assembly, the third rotor assembly, and the center rotor assembly simultaneously create lift and thrust during flight.
